(19) United States
(12) Patent Application Publication
(10) Pub. No.: US 2007/0067168 A1
(43) Pub. Date: Mar. 22, 2007

(54) Method and device for transcribing an audio signal

(75) Inventors: Gerhard Grobauer, Vienna (AT); Miklos Papai, Budapest (HU); Kwaku Frimpong-Ansah, Vienna (AT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/580,502

(22) PCT Filed: Nov. 24, 2004
(86) PCT No.: PCT/IB04/52529

§ 371 Date: May 23, 2006

(30) Foreign Application Priority Data
Nov. 28, 2003 (EP) 03104444.9

(51) Int. Cl. G10L 15/26

(52) U.S. Cl. 704/235

(57) ABSTRACT

In the case of a method for transcribing an audio signal (AS) containing signal portions (SP) into text containing text portions (TP) for a document (DO), this document (DO) being envisaged for the reproduction of information, this information corresponding at least in part to the text portions (TP) obtained through the transcription, it is envisaged that signal portions (SP) are transcribed into text portions (TP), and relational data (RD) are produced which represent at least one temporal relation between respectively at least one signal portion (SP) and respectively at least one text portion (TP) obtained through the transcription, and that a structure of the document (DO) is recognized and that the recognized structure of the document (DO) is depicted in the relational data (RD).

The invention relates to a method for transcribing an audio signal containing signal portions into text containing text portions for a document, this document being envisaged for the reproduction of information, this information corresponding at least in part to the text portions obtained through the transcription.

The invention further relates to a device for transcribing an audio signal containing signal portions into text containing text portions for a document, this document being envisaged for the reproduction of information, this information corresponding at least in part to the text portions obtained through the transcription.

The invention further relates to a computer program product which is suitable for transcribing an audio signal.

The invention further relates to a computer that runs the computer program product as claimed in the previous paragraph.

Such a method and such a device and such a computer program product and such a computer are known from patent document U.S. Pat. No. 5,031,113.

In the case of the known device, with the aid of which the known method can be executed and which is realized with the aid of the known computer that processes the known computer program product, a document is produced on the basis of an audio signal. In the course of this, signal portions contained in the audio signal are recognized as text portions and are stored. Furthermore, relational data are produced and stored which represent a temporal relation of the signal portions to the recognized text portions. With the aid of the device, the audio signal can be reproduced in an acoustic manner via a loudspeaker, and the document can be reproduced in a visual manner via a monitor. In an acoustic reproduction of the audio signal, the relational data are used for the synchronized visual emphasis of the text portions that stand in a temporal relation to the respective signal portions, which is known in expert circles by the term “synchronous playback”.

In the case of the known device, the problems exists that in the case of a document that contains not just the text produced through transcription but also other elements, such as for example unchangeable form field designations or pictures or text blocks or audiovisual objects, when “synchronous playback” is used, and in fact in particular in connection with the situation where the text produced through transcription is read through and checked by an employee who has not dictated the text himself, considerable difficulties can occur, since these other elements that were not produced through transcription cannot be taken into account, or cannot be taken into account sufficiently.

It is an object of the invention to eliminate the problems in the case of a method of the type mentioned in the first paragraph and in the case of a device of the type mentioned in the second paragraph and in the case of a computer program product of the type mentioned in the third paragraph and in the case of a computer of the type mentioned in the fourth paragraph, and to create an improved method and an improved device and an improved computer program product and an improved computer.

To achieve the object stated above, in the case of a method in accordance with the invention, features in accordance with the invention are envisaged, so that a method in accordance with the invention can be characterized in the manner as stated below.

A method for transcribing an audio signal containing signal portions into text containing text portions for a document, this document being envisaged for the reproduction of information, this information corresponding at least in part to the text portions obtained through the transcription, this method having the steps listed below, namely:
transcription of the signal portions into text portions and production of relational data which represent at least one temporal relation between respectively at least one signal portion and respectively at least one text portion obtained through transcription, and recognition of a structure of the document and depiction of the recognized structure of the document in the relational data.

To achieve the object stated above, in the case of a device in accordance with the invention, features in accordance with the invention are envisaged, so that a device in accordance with the invention can be characterized in the manner as stated below:

A device for transcribing an audio signal containing signal portions into text containing text portions for a document, this document being envisaged for the reproduction of information, this information corresponding at least in part to the text portions obtained through the transcription, with transcription means for transcribing the signal portions into text portions, and with relational data production means which are designed for the production of relational data, these relational data representing at least one temporal relation between respectively at least one signal portion and respectively at least one text portion obtained through the transcription, and with structure recognition means which are designed for recognizing a structure of the document, and with structure depiction means which are designed for depicting the recognized structure of the document in the relational data.

To achieve the object stated above, in the case of a computer program product that is suitable for the transcription of an audio signal, according to the invention it is envisaged that the computer program product can be loaded directly into a memory of a computer and comprises software code sections, wherein with the computer the method according to the invention can be executed when the computer program product is run on the computer.

To achieve the object stated above, in the case of a computer in accordance with the invention, it is envisaged that the computer has a computing unit and an internal memory, and runs the computer program product according to the paragraph given above.

Through the provision of the measures according to the invention, the advantage is achieved that a structure of the document to be produced is manifested not only in the document itself, but also in the relational data, through which considerably more complex documents can be produced and above all can be further processed in an audiovisual manner.

Through the provision of the additional measures as claimed in claim 2 or claim 9, furthermore the advantage is achieved that an already existing structure in a document prepared as a template, such as for example a document structure that is given by predefined form fields, is depicted reliably in the relational data.

Through the provision of the additional measures as claimed in claim 3 or claim 10, furthermore the advantage is achieved that the structure of a document, which is recognized only through structural instructions that are contained in the audio signal that is to be transcribed, because for example they were dictated by a person, is therefore recognized practically in real time, i.e. during transcription, and is reliably depicted in the relational data.

In the case of a solution in accordance with the invention, it can for example be envisaged that for each recognized structure element of the document, a separate file with relational data is produced, i.e. a physical grouping of the relational data takes place. It has however been shown to be particularly advantageous if, in addition, the measures according to claim 4 or claim 11 are envisaged, since with this, as simple and reliable a grouping into a single file as possible can be realized, so that a relatively time-consuming processing of several files is avoided. In this case, the grouping of the relational data can for example take place through marking of the relational data with the aid of structural data which represent the recognized structure of the document. It can however also be envisaged that the relational data that belong together structurally are grouped in sections in the single file, with each section being assigned to a structure element of the recognized structure of the document.

Through the provision of the measures as claimed in claim 5 or claim 12, furthermore the advantage is achieved that the efficiency in the recognition of text portions is increased. This is the case in particular since for example in the case of a document that represents a report by a radiologist, in the case of transcription of administrative instructions by the radiologist, the radiological context is not required, but a considerably more restricted context relating to general instructions is sufficient. The same applies where a summary of a report is to be transcribed and for example essentially it is known in advance that in the summary, mainly standard formulations or standard phrases will be used. The same applies where the structure in a document is given through different languages, which for example are used in sections. Thus for example where a first language model or a second language model are available, it is ensured that the transcription takes place under automatic selection of the respective language model, and if applicable the document is subsequently selectively processed further, in accordance with the structure given by the two different languages, by different editing personnel.

Through the provision of the measures as claimed in claim 6 or claim 13, the advantage is achieved that all textual elements of the document that arise through transcription can be reproduced coherently without problems and above all in the correct sequence, with non-textual elements being omitted.

Through the provision of the measures as claimed in claim 7 or claim 14, the advantage is achieved that a coherent acoustic reproduction of text portions can be carried out which on the one hand were produced through the transcription of the audio signal and which on the other hand arose in ways other than through the transcription of the audio signal. Such text portions that have arisen in other ways can for example have arisen through manual input of text into the document or through the insertion of predefined text elements or text objects, such as for example field designations of a form, or through an insertion of predefined text blocks, or through correction of the text that has arisen through transcription.

These and other aspects of the invention are apparent from and will be elucidated with reference to the embodiment described hereinafter.

The invention is described in further detail below on the basis of a design example represented in the drawings, to which however the invention is not restricted.

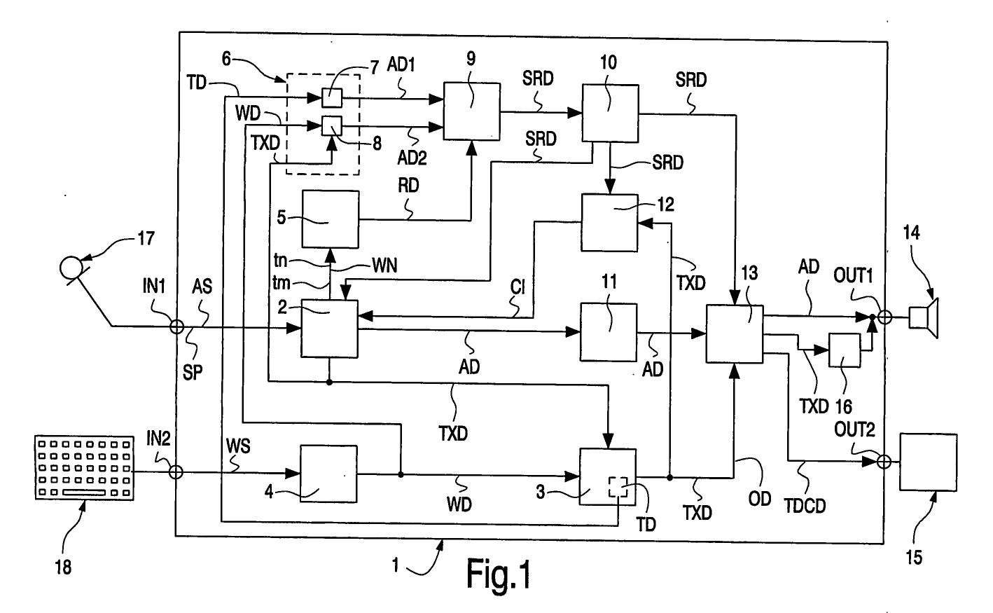

FIG. 1 shows in schematic manner in the form of a block diagram a device according to an example of embodiment of the invention.

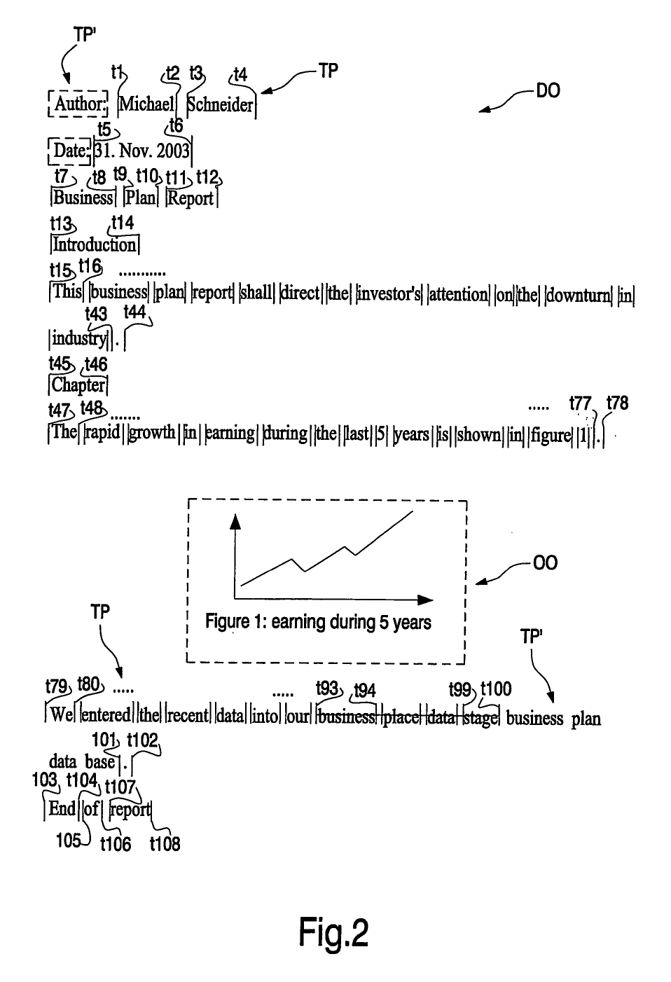

FIG. 2 shows in plain text some information that is contained in a document that is processed with the aid of the device according to FIG. 1.

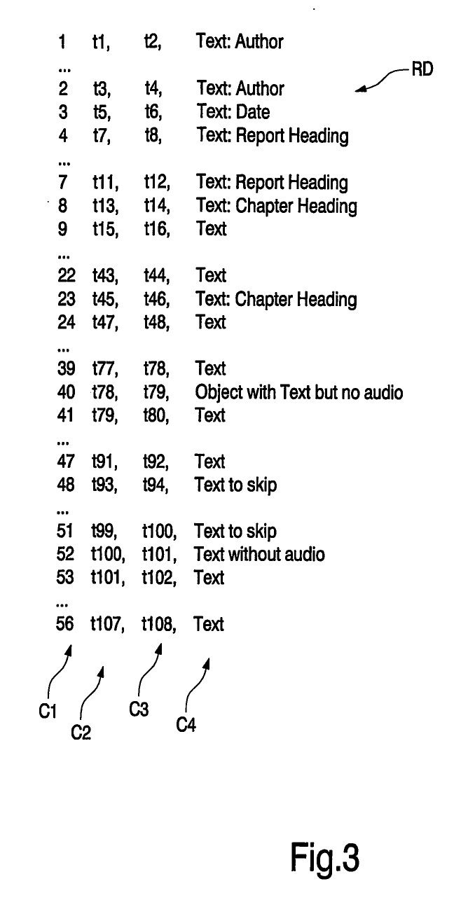

FIG. 3 shows, in plain text, relational data divided with regard to a structure of the document according to FIG. 2, which reproduce at least one temporal relation between signal portions of a audio signal and text portions of a text of the document.

Shown in FIG. 1 is a device 1 that is designed for transcribing an audio signal AS containing signal portions SP into text containing text portions TP for a document DO. The audio signal represents dictation given by a speaker. Shown in FIG. 2 is a document DO that is envisaged for the reproduction of information, this information corresponding at least in part to the text portions TP obtained through the transcription. In the present case, the document DO has template portions that do not correspond to the transcribed text portions TP, such as for example predefined form field designations “Author:” or “Date:”, which are set in a fixed manner in a document template.

The device 1 has a first input IN1, at which the audio signal AS can be supplied to it. It is noted that the audio signal AS can also be supplied in another way, such as for example with the aid of a data carrier or via a data network in the form of a digital representation, if the device 1 has means that are set up in an essentially familiar manner.

The device 1 furthermore has a second input IN2, at which processing signals WS can be supplied to it; this is dealt with in detail later.

The device 1 furthermore has transcription means 2 which are designed for receiving the audio signal AS and for transcribing the signal portions SP into the text portions TP. In this connection it is noted that it is an obvious matter for the person skilled in the art to condition the audio signal AS accordingly, wherein for example filter elements and conversion elements are used for conversion into a digital representation; this is not dealt with in further detail here. The transcription of the signal portions SP takes place taking into account speaker data, not shown explicitly in FIG. 1, and a selectable context. Context data, which are likewise not shown explicitly in FIG. 1, represent the various contexts available to choose from, wherein each context defines or comprises a language, a language model and a lexicon. The speaker data are representative for the respective speaker. On the basis of the supplied audio signal AS, the transcription means 2 are designed to produce text data TXD, which represent the recognized text portions TP.

The device 1 furthermore has document data storage media 3 which are designed and provided for storing the document DO, and the template data TD intended for the document DO, and the text data TXD. The transcription means 2 are designed to work together with the document data storage media 3, so that the text data TXD can be inserted into the areas of the document DO that are intended for this. Furthermore, with the aid of the document data storage media 3, object data OD can be stored which represent objects OO inserted into the document DO; this will be dealt with further below.

The device 1 furthermore has document processing means 4 which are designed to receive processing signals WS via the second input IN2. The document processing means 4 are furthermore designed, taking into account the processing signal WS, to produce and deliver processing data WD, which are provided for changing the text portions TP produced with the aid of a transcription of the signal portions SP in the document data storage media 3. With the aid of the document processing means 4, for example the text portions TP shown in FIG. 2 and obviously wrongly recognized can be corrected between the time markers t93 and t100, which is illustrated by the striking through of these text portions TP between the text markers t93 and t100 and by insertion of corrected text portions TP′ between the text marker t100 and t101. For the further text portions TP′ obtained through correction measures, there are no corresponding signal portions SP in the audio signal AS, since they were inserted manually. The same applies for the object OO shown in FIG. 2.

The transcription means 2 are furthermore designed to produce and deliver information relating to a starting point in time tn and an end point in time tm of a signal portion SP within the audio signal AS, and information relating to a text portion number WN which represents the number of the text portions TP respectively produced with the aid of the transcription means 2.

The device 1 furthermore has relational data production means 5 which are designed for the production of relational data RD, these relational data RD representing a temporal relation between respectively one signal portion SP and respectively at least one transcribed text portion TP. For this purpose, the relational data production means 5 are designed for receiving and processing the information relating to a starting point in time tn and an end point in time tm of the signal portions SP within the audio signal AS and the information relating to a text portion number WN. The relational data production means 5 are furthermore designed for delivering the relational data RD.

The device 1 furthermore has structure recognition means 6 which are designed for recognizing a structure of the document DO, which is dealt with in detail below.

For the purpose of recognizing the structure of the document DO, the structure recognition means 6 have a first analysis stage 7 which is designed to analyze the document DO in respect of a structure. The first analysis stage 6 [sic] is designed to access the document data storage media 3 and to read and take account of the template data TD. The first analysis stage 6 [sic] is designed as a result of its analysis to deliver first analysis data AD1, which represent a structure of the document DO that is recognizable on the basis of the template data TD. In the present case, this recognizable structure relates to the presence of two form fields envisaged for the input of text which are arranged adjacent to the two form field designations “Author:” and “Date”. The recognizable structure can however also be given through pictures or unchangeable pieces of text. It is noted at this point that apart from structure elements that are visible to a user of the document, even in normal use of the document invisible structure elements are taken into account, which are defined through settings which for example in the case of current word processing programs are known as so-called bookmarks or so-called structuring, and cannot be counted towards the information that is to be reproduced for the user through the document, since they are mainly used in connection with control of inputs, control of outputs, or automation of the processing of the document.

For the purpose of recognizing the structure of the document DO, the structure recognition means 5 furthermore have a second analysis stage 8 which is designed to analyze the obtained text portions TP in respect of a structure of the document DO. The second analysis stage 8 is designed for receiving the text data TXD transcribed from the signal portions SP and for analyzing the text data TXD in respect of structural instructions uttered by the speaker, wherein the structural instructions are envisaged or are suitable for producing and/or altering and/or setting a structure in the document DO. This can involve for example spoken format allocations, such as for example allocation of heading formats that are intended for the formatting of headings, to individual pieces of text that are to be formatted as headings, or also insertion, deletion or overwriting of text portions TP that are effected through spoken commands.

The second analysis stage 8 is furthermore designed to receive the processing data WD and to analyze the processing data WD in relation to an alteration of an existing structure of the document DO caused with the aid of the processing data WD, or in relation to a newly defined structure in the document DO. This can involve, for example, an alteration of a hierarchy of headings or an insertion or removal of elements such as for example pictures, texts or objects for which no corresponding signal portions SP exist in the audio signal AS. It is also noted at this point that the second analysis stage 8 can also be designed for accessing the document data storage media 3 and for analyzing the structure of the document DO that has arisen through language or manual processing.

The second analysis stage 8 is designed analogously to the first analysis stage 7 to deliver second analysis data AD2 that represent the result of the analysis.

The device 1 furthermore has structure depiction means 9 which are designed for receiving the first analysis data AD1 and the second analysis data AD2 and the relational data RD. The structure depiction means 9 are designed, with the aid of the first analysis data AD1 and the second analysis data AD2, to depict in the relational data RD the structure of the document DO that is represented or recognized by the analysis data AD1 and AD2. The structure depiction means 9 are furthermore designed to deliver relational data SRD which are structured in respect of the structure of the document DO, which in the present case represent a logical grouping of the relational data RD shown in FIG. 3.

The device 1 furthermore has relational data storage media 10 which are designed for storing the structured relational data SRD. The structure depiction means 9 are provided for accessing the relational data storage media 10, wherein the structured relational data SRD can be stored in the relational data storage media 10, or relational data SRD that are already stored can be altered.

In FIG. 3, reproduced in the plain text is a depiction of the structured relational data SRD for the document DO shown in FIG. 2. FIG. 3 shows entries, listed line by line, which correspond to the elements of the document DO and are numbered with the aid of the numbers one (1) to fifty-six (56). A first column C1 shows the number of the respective document entry. A second line [sic] C2 shows the respective starting point in time of a signal portion SP within the audio signal AS, which corresponds to the element of the document DO through the respective number, such as for example a text portion TP transcribed from a signal portion SP. A third column C3 shows the respective end point in time of the aforementioned signal portion SP within the audio signal AS. As can be seen from FIG. 3, the document entries represented with the aid of the structured relational data relate not only to those elements that were produced with the aid of the transcriptions of the audio signal AS, but also to those elements that were produced in other ways and which are localized in the document between the signal portions SP of the audio signal AS, such as for example the elements of the line 40 and 52. A column C4 represents, for the respective document entry, its affiliation to a structure contained in the document DO. It is particularly pointed out here that even document entries such as, for example, those document entries registered between the time markers t78 and t79, or between the time markers t100 and t101, are manifested in the relational data RD, for which document entries no audio signal AS exists, in order to be able, later, to ensure if necessary an audio reproduction of the audio signal AS that includes or omits such elements, or [to ensure] that it is possible to retrace the formation and/or alteration of the document.

The device 1 furthermore has audio data storage media 11 that are designed to store audio data AD which represent the audio signal AS and are delivered by the transcription means 2 to the audio signal storage media 11. The audio data AD represent the audio signal AS in an essentially familiar manner in a digital representation, in which the signal portions SP can be accessed for later reproduction of the audio signal AS, taking into account the structured relational data SRD.

The transcription means 2 can furthermore be configured depending on the recognized structure of the document DO, i.e. depending on the structured relational data SRD, wherein in the present case a choice is made between three different contexts depending on the structure. Thus where it is recognized that we are dealing with a structure element “report heading”, a first context is selected, and where it is a structure element “chapter heading”, a second context is selected, and where it is a structure element “text”, the third context is selected. Through this, it is ensured that as soon as the structure element “text” is present, the context with the maximum lexical scope is provided, which is usually not necessary for the transcription of signal portions SP which relate to the structure element “report heading” or “chapter heading”. Furthermore, where it is recognized that it involves the structure element “author”, a fourth context—essentially relating to names—is selected. Furthermore, where it is recognized that it involves the structure element “date”, a fifth context—essentially relating to date details—is selected.

At this point it is noted that, taking into account the recognized structure, the language or the language model or also a choice between different speaker data can be made. It is furthermore mentioned that taking account of a structure of the document DO in the case of the transcription means 2 need not take place only once the recognized structure has already arrived in the structured relational data SRD, but that the structure can already be taken into account on the basis of the first analysis data AD1 and/or of the second analysis data AD2, as soon as these are delivered by the structure recognition means 6 for example directly to the transcription means 2.

The device 1 furthermore has adaptation means 12 which, with the assistance of the structured relational data SRD, are designed to adapt the respective context for the transcription means 2. For this purpose, the adaptation means 12 are designed for reading the structured relational data SRD from the relational data storage media 9, and for reading the text data TXD from the document storage media 3, and for analyzing the text data TXD using the structured relational data SRD, and/or for analyzing the alterations to the text data TXD that have been logged, after the first production and storage of the text data TXD, with the aid of the structured relational data SRD. As a result of the analysis of the text data TXD, the adaptation means 12 are designed to deliver alteration or adaptation information CI to the transcription means 2, with the aid of which the respective context can be adapted, so that in future better results are obtained in the case of transcription.

The device 1 furthermore has reproduction control means 13 which, taking into account the recognized structure of the document DO, are designed to effect an acoustic reproduction of the signal portions SP of the audio signal AS synchronously with a visual emphasis of the transcribed text portions TP in the case of a visual reproduction of the text portions TP of the document DO. For this purpose, the reproduction control means 13 are designed for accessing the structured relational data SRD stored in the relational data storage media 10, and for accessing those text data TXD stored in the document storage media 3, which with the aid of the structured relational data SRD, are identified as those text data TXD for which signal portions SP exist, which are represented with the aid of the audio data AD. The reproduction control means 13 are furthermore designed for accessing the signal portions SP in the audio data AD, these signal portions SP being limited in time by the respective time markers tn and tm logged in the structured relational data SRD. The reproduction control means 13 are furthermore designed for the synchronous delivery of the audio data AD representing the respective signal portions SP to a first reproduction device 14, and for transmitting the chronologically corresponding text display control data TDCD to a second reproduction device 15. With the aid of the text display control data TDCD, first of all the information of the document DO can be delivered to the second reproduction device 15, which is designed for the visual reproduction of this information, and secondly a synchronous emphasis of the respective text portion TP can be defined, whilst the signal portion SP corresponding to that is delivered in the form of the audio data AD to the first reproduction device 14.

In the present case, both the first reproduction device 14, which is realized by an audio amplifier with integrated loudspeaker, and the second reproduction device 15, which is realized by a monitor, are connected to the device 2 respectively via an assigned signal output OUT1 and OUT2. It is however mentioned at this point that the two devices 14 and 15 can also be formed by a combination device which is connected to the device 2 via a single signal output of the device 2. Furthermore, the two devices 14 and 15 can also be integrated in the device 1.

The device 1 has speech synthesis means 16 which is designed for synthesizing text data TXD into synthetic speech, and which serves to make acoustic reproduction accessible by synthethis means for those text portions TP′ for which no signal portions SP exist in the audio signal AS. The speech synthesis means 16 are connected on the input side with the reproduction control means 13, and on the output side with the signal output OUT1.

The reproduction control means 13 are furthermore designed to co-operate with the speech synthesis means 16, and with the assistance of the speech synthesis means 16 to effect an acoustic reproduction of further text portions TP′ that have been produced additionally to the text portions TP obtained through transcription of the audio signal AS, these further text portions TP′ existing adjacent to the text portions TP obtained through the transcription of the audio signal AS in the document DO. If necessary, an interruption of the reproduction of the audio signal AS during the reproduction of the further text portions TP′ can be carried out, with monitoring of the reproduction control means 13, if these further text portions TP′ have for example arrived in the document DO as a constituent part of the object OO or through correction, as illustrated on the basis of FIG. 2.

In the following, the method of operation of the device 1 is now explained on the basis of a design example of the device 1 according to FIG. 1.

In accordance with the application example, it is assumed that a businessman is dictating a report relating to a business plan. With the aid of a microphone 17 connected to the first input IN1, the audio signal AS is produced and supplied to the device 1.

With the aid of the device 1, a method for transcribing the audio signal AS can be carried out. At the start of dictation, the document DO shown in FIG. 2 in its final processing state is essentially empty and has only the predefined and unalterable template data TD, which represent predefined form field designations, and in fact in the present case the form field designations “Author:” and “Date:”.

In the case of this method, signal portions SP are transcribed into corresponding text portions TP, and relational data RD are produced which represent the temporal relation between respectively one signal portion SP and respectively at least one transcribed text portion TP.

In the present case, the businessman first of all dictates the words: “Author: Michael Schneider”.

In order to improve the recognition and transcription process, with the aid of the device 1, a structure of the document DO is recognized and the recognized structure of the document DO is depicted in the relational data RD. For this purpose, starting with the reception of the audio signal AS, the structure of the document DO is analyzed with the aid of the first analysis stage 7 and it is established that the two aforementioned form field designations exist. The first analysis data AD1 represent this analysis result, which is depicted with the aid of the structure depiction means 9 in the relational data RD by the production of the structured relational data SRD, which in the case of the transcription means 2 are used to discard the signal portions which represent the spoken words: “Author:”. Furthermore, for the transcription the fourth context is selected, in which only some known names are available for selection. This accelerates and improves the transcription of the words contained between the text time markers t1 to t4 shown in FIG. 2. The transcription of the date takes place analogously; this is represented with the aid of several signal portions SP, using the fifth context. Here, the signal portion SP occurring between the time markers t5 and t6 are grouped together, since on recognizing a structure element indicating a date, the transcription means 2 apply a predefined date form.

After dictating the entries for the form fields, the businessman can define any structure for the subsequent text. In order to take account of this, according to the method an analysis takes place of the recognized text portions TP, i.e. of the text data TXD, in respect of the structure of the document DO that is to be created. Thus for example the businessman dictates the phrase: “Report heading Business Plan Report”. With the aid of the second analysis stage 8, using the recognized text portions TP it is then recognized that this is a structure element relating to the main heading of the document DO.

Accordingly, the text portions TP recognized between the time markers t7, t8 and t9, t10 and t11, t12 are assigned to the structure element “report heading”, as shown in FIG. 3, with a logical grouping of the relational data RD as structured relational data SRD taking place.

After this structure element has been recognized on the basis of the words “report heading”, on the basis of the recognized structure elements, for the transcription means 2, a configuration of the transcription means 2 takes place such that the second context is used, which contains the most general expressions for headings in an everyday business context.

The businessman continues his dictation with the words “chapter heading introduction”, which likewise leads to a further structure element, namely the structure element “chapter heading”, being recognized. In this case, the second context is selected, which however in comparison with the context relating to the main heading, has a wider lexical scope. Furthermore, the recognized text portion TP, which corresponds to the signal portion SP between the time markers t13 and t14, is marked in the relational data storage media 9 by the structure element “chapter heading”.

Since no further spoken structural instructions occur in the next spoken phrase, which is represented by signal portions SP between the time markers t15 to t44, the context containing the largest lexicon is selected for the transcription, and the relational data RD for these signal portions SP are assigned to the structure element “text”.

After that, once again on the basis of the dictated text the structure element “chapter heading” is recognized and the text portion TP that corresponds to the signal portion between the time markers t45 and t46 is logically assigned to this structure element.

The next sentence to be uttered, which is bounded by the time markers t47 to t78, is assigned to the structure element “text” due to the lack of any recognizable structure elements, wherein once again the third context, which has the largest lexicon, is applied for the transcription.

After that, the businessman inserts into the document DO an object OO which has both a graphic and a text; however, no audio signal AS corresponds to this text, since it was produced through a textual input. The insertion of the object OO takes place in the present case with the aid of tactile input means 18, namely a keyboard which is connected to the second input IN2, and the word processing medium 4. It is however mentioned that the insertion of the object OO can be produced through spoken commands which are transcribed with the aid of the transcription means 2 and are recognized as commands and executed by other means in the device 1, not shown here. Accordingly, in the present case the insertion of the object OD [sic] is recognized with the aid of the second analysis stage 8, and in the relational data storage media 9, the presence of this object is noted between the time markers t78 and t79.

The next dictated text, between the time markers t79 and t100, is initially assigned to the structure element “text”. However, in the transcription using the third context, errors have occurred between the time markers t93 and t100, which are corrected by the businessman with the aid of the input means 18. For this purpose, the text portions TP between the time markers t93 and t100 are deleted and new text portions TP′ are added which replace the deleted text portions TP and are established before the time marker t101. With the aid of the second analysis stage 8, this change is registered or recognized in the document DO, and the text portions TP originally placed in front between the time markers t93 and t100 are marked with the structure element “text to skip”, so that in the case of an acoustic reproduction of the stored audio data AD, these text portions TP are skipped. Furthermore, the further text portions TP′ which were manually entered before the time marker t101 are marked by the structure element “text inserted: no audio”, which defines the fact that this is a dictated text which however was subsequently corrected or revised, and that for the newly added text portions TP′ no corresponding signal portions SP are contained in the stored audio data AD.

The signal portions SP that occur next in the dictation are characterized in the relational data storage media 9 by the structure element “text”, since no other structure elements can be recognized with the aid of the structure recognition means 5, and therefore cannot be allocated.

Following dictation of the text, and possibly correction of the dictated text, the businessman can, according to the method, activate a reproduction mode, with the aid of which a precise audiovisual tracking of the transcribed audio signal AS is made possible, synchronous to a visual emphasis of the text portions TP corresponding to the signal portions SP respectively indicated by the time markers tn and tm, wherein the synchronous audiovisual reproduction of the text portions TP and of the signal portions SP takes place utilizing the structured relational data SRD. Through this it is achieved that for example non-dictated elements of the document OD are skipped or ignored in the case of visual emphasis.

According to the method it is furthermore ensured that the further text portions TP′ that are produced in addition to the text portions TP that were produced through the transcription of the audio signal AS are reproduced with the aid of speech that can be produced by synthethis means, i.e. by speech synthesis means 16. The method furthermore ensures that the reproduction of the audio signal AS during the reproduction of the further text portions TP′ is interrupted if necessary if the further text portions are embedded between text portions TP that have been produced through transcription.

Through this it is achieved that corrections or insertions too, according to their position in the document DO, are taken into account in the reproduction in the correct sequence or in the correct connection with the text portions TP that have arisen though transcription.

In the present case the device 1 is realized by a computer, not shown in FIG. 1, with a computing unit and an internal memory, which runs a computer program product The computer program product is stored on a computer-readable data carrier or medium, not shown in FIG. 1, for example on a DVD or CD or non-volatile semi-conductor memory. The computer program product can be loaded from the computer-readable medium into the internal memory of the computer, so that with the aid of the computer, the method according to the invention, for transcribing signal portions SP into text portions TP, is carried out when the computer program product is run on the computer.

It is noted at this point that the device 1 can also be realized through several computers which are distributed over a computer network and which work together as a computer system, so that individual functions of the device 1 can for example be taken over by individual computers.

It is noted that the coherent reproduction of the text portions TP and of the other text portions TP′ is ensured even if the further text portions TP′ that have been obtained in other ways are located at the start or end of the text portions TP obtained through transcription.

It is noted that the structured relational data SRD can also comprise spoken or manually activated commands, through which a further contribution is made to the ability to retrace the formation of the information that can be reproduced by the document.

It is furthermore noted that the device according to the invention can also be used privately or for medical purposes or in the field of safety engineering, wherein this listing is not conclusive.

With regard to the allocation between signal portions SP and text portions TP obtained through transcription, it is noted that for example the spoken word “Today” is recognized as a coherent signal portion SP and that from that several text portions TP, namely “31st Nov. 2003” are produced through transcription, so that in the present case the relational data RD reproduce the temporal relation between a single signal portion SP and three text portions TP. In this connection it is furthermore noted that the allocation between signal portions SP and text portions TP obtained through transcription can also be given such that for example the spoken date “31st Nov. 2003”, which is represented by at least three signal portions SP, namely those which represent the word “31^{st}” and “November” and “2003”, are grouped together through transcription to a single text portion TP, for example “today” or “tomorrow” or “yesterday”, so that in the present case the relational data RD reproduce the temporal relation between three signal portions SP and one text portion TP.

1. A method for transcribing an audio signal (AS) containing signal portions (SP) into text containing text portions (TP) for a document (DO), this document (DO) being envisaged for the reproduction of information, this information corresponding at least in part to the text portions (TP) obtained through the transcription, this method having the steps listed below, namely:
transcription of the signal portions (SP) into text portions (TP) and
production of relational data (RD) which represent at least one temporal relation between respectively at least one signal portion (SP) and respectively at least one text portion (TP) obtained through transcription, and
recognition of a structure of the document (DO) and
depiction of the recognized structure of the document (DO) in the relational data (RD).

2. A method as claimed in claim 1, wherein the recognition of the structure of the document (DO) takes place through analysis of the document (DO).

3. A method as claimed in claim 1, wherein the recognition of the structure of the document (DO) takes place through analysis of the recognized text portions (TP).

4. A method as claimed in claim 1, wherein the depiction of the recognized structure of the document (DO) takes place through a logical grouping of the relational data (RD).

5. A method as claimed in claim 1, wherein transcription means (2), provided for the transcription of text portions (TP), are configured depending on the recognized structure.

6. A method as claimed in claim 1, wherein an acoustic reproduction of the signal portions (SP) of the audio signal (AS) takes place at the same time as a visual emphasis of the transcribed text portions (TP) with a visual reproduction of the text portions (TP), and in the course of this the recognized structure of the document (DO) is taken into account.

7. A method as claimed in claim 3, wherein further text portions (TP′), produced in addition to the text portions (TP) obtained through the transcription of the audio signal (AS), which further text portions (TP′) exist adjacent to the text portions (TP) obtained through the transcription of the audio signal (AS) in the document (DO), are reproduced with the aid of speech that can be created by synthethis means, and wherein if necessary the reproduction of the audio signal (AS) is interrupted during the reproduction of the further text portions (TP′).

8. A device (1) for transcribing an audio signal (AS) containing signal portions (SP) into text containing text portions (TP) for a document (DO), this document (DO) being envisaged for the reproduction of information, this information corresponding at least in part to the text portions (TP) obtained through the transcription, with transcription means (2) for the transcription of the signal portions (SP) into text portions (TP), and
with relational data production means (5) which are designed for the production of relational data (RD), these relational data (RD) representing at least one temporal relation between respectively at least one signal portion (SP) and respectively at least one text portion (TP) obtained through transcription, and
with structure recognition means (6) which are designed for recognizing a structure of the document (DO), and
with structure depiction means (9) which are designed for depicting the recognized structure of the document (DO) in the relational data (RD).

9. A device (1) as claimed in claim 8, wherein the structure recognition means (6) are realized with the aid of a first analysis stage (7) which is designed for analyzing the document (DO) in respect of its structure.

10. A device (1) as claimed in claim 8, wherein the structure recognition means (6) are realized with the aid of a second analysis stage (8), which is designed for analyzing the text portions (TP) obtained in respect of a structure of the document (DO).

11. A device (1) as claimed in claim 8, wherein the structure depiction means (9) are designed for the logical grouping of the relational data (RD).

12. A device (1) as claimed in claim 8, wherein the transcription means (2) can be configured depending on the recognized structure.

13. A device (1) as claimed in claim 8, wherein reproduction control means (13) are provided which, taking into account the recognized structure of the document (DO), is designed to effect an acoustic reproduction of the signal portions (SP) of the audio signal (AS) at the same time as a visual emphasis of the transcribed text portions (TP) in the case of a visual reproduction of the text portions (TP).

14. A device (1) as claimed in claim 13, wherein speech synthesis means (16) are provided which are designed for synthesizing text portions (TP, TP′) into speech, and wherein with the aid of the speech synthesis means (16), the reproduction control means (13) are designed to effect an acoustic reproduction of further text portions (TP′) that are produced in addition to the text portions (TP) obtained through the transcription of the audio signal, which further text portions (TP′) exist adjacent to the text portions (TP) obtained through the transcription of the audio signal (AS) in the document (DO), wherein if necessary an interruption of the reproduction of the audio signal (AS) can be effected during the reproduction of the further text portions (TP′).

15. A computer program product which is suitable for the transcription of an audio signal (AS) and
which can be loaded directly into a memory of a computer and
includes software code sections, wherein with the computer, the method as claimed in claim 1 can be executed when the computer program product is run on the computer.

16. A computer program product as claimed in claim 15, wherein the computer program product is stored on a computer-readable medium.

17. A computer with a computing unit and an internal memory, which runs the computer program product as claimed in claim 15.
